(19) United States
(12) Patent Application Publication
(10) Pub. No.: US 2020/0346699 A1
(43) Pub. Date: Nov. 5, 2020

(54) METHOD OF TRAVERSING DIFFICULT TERRAIN

(71) Applicant: Foster-Miller, Inc., Waltham, MA (US)

(72) Inventors: David C. Meeker, Natick, MA (US); Timothy J. Mason, Uxbridge, MA (US); Andrew Kirouac, Chelmsford, MA (US); Christopher Leon, Somerville, MA (US); William Abraham Crowley, Pittsburgh, PA (US); Ryan Wasserman, Medford, MA (US); Richard Wiesman, Wayland, MA (US)

(21) Appl. No.: 16/863,306

(22) Filed: Apr. 30, 2020

Related U.S. Application Data
(60) Provisional application No. 62/841,352, filed on May 1, 2019.

(51) Int. Cl. B62D 55/075; B62D 55/065

(52) U.S. Cl. CPC B62D 55/075; B62D 55/12; B62D 55/0655

(57) ABSTRACT

A method of operating a mobile remotely controlled ground robot in difficult terrain. Rear driven tracked arms of the robot are pivoted rearward and upward to trail main driven tracks of the robot at a fixed angle relative to and above the ground. The main tracks of the robot are driven forward to traverse the ground. An obstacle is traversed by driving the main tracks to traverse the obstacle pivoting the forward end of the robot upwards and at least one of the rear driven tracks are driven and engaging the ground and/or obstacle to advance the robot forward over the obstacle and to prevent the robot from tipping over backwards.

### RELATED APPLICATIONS

This application claims benefit of and priority to U.S. Provisional Application Ser. No. 62/841,352 filed May 1, 2019, under 35 U.S.C. §§ 119, 120, 363, 365, and 37 C.F.R. § 1.55 and § 1.78, which is incorporated herein by this reference. This application is also related to U.S. patent application Ser. No. 15/704,223 filed on Sep. 14, 2017 which claims the benefit of and priority to U.S. Provisional Application Ser. No. 62/396,990 filed Sep. 20, 2016 under 35 U.S.C. §§ 119, 120, 363, 365, and 37 C.F.R. § 1.55 and § 1.78, and is related to U.S. patent application Ser. No. 15/704,379 filed on Sep. 14, 2017 which claims the benefit of and priority to U.S. Provisional Application Ser. No. 62/397,055 filed Sep. 20, 2016 under 35 U.S.C. §§ 119, 120, 363, 365, and 37 C.F.R. § 1.55 and § 1.78. All said applications are incorporated herein by reference.

### FIELD OF THE INVENTION

This subject invention relates to remotely controlled maneuverable ground robots.

### BACKGROUND OF THE INVENTION

Several existing ground robots are fairly maneuverable but are fairly heavy and too large to fit in a soldiers backpack. See, for example, U.S. Pat. Nos. 8,201,649; 5,022,812 and 7,597,162 incorporated herein by this reference. Other robots are smaller in weight and can be placed in a backpack but are not maneuverable enough, for example, to climb stairs. See U.S. Pat. No. 9,180,920 and published U.S. Patent Application No. 2009/0266628 incorporated herein by this reference. See also WO/2018/027219 (PCT/US2017/1045736) incorporated herein by this reference.

### BRIEF SUMMARY OF THE INVENTION

Featured is a lightweight, compact, man packable robot which in one example is highly mobile, unmanned, and can include advanced sensors and mission modules for dismounted forces. In one example, the ground robot is particularly useful for clearing buildings, caves, and other restricted terrain where close quarters combat is likely.

Also featured is a method of operating a mobile remotely controlled ground robot in difficult terrain. The rear driven tracked arms of the robot are pivoted rearward and upward to trail main driven tracks of the robot at a fixed angle relative to and above the ground. The main tracks of the robot are driven forward to traverse the ground. A positive or negative obstacle is traversed by driving the main tracks and pivoting the forward end of the robot upwards. But, at least one of the rear driven tracks is then driven and engages the ground and/or obstacle to advance the robot forward over the obstacle and preventing the robot from tipping over backwards.

Preferably, both of the rear driven tracks are driven and engage the ground and/or obstacle. In one version, the rear driven tracks are driven forward while the main tracks are driven forward to traverse the ground. And, the rear driven tracks can be driven at the same speed as the main driven tracks.

Preferably, the center of gravity of the robot is rearward of the front of the robot main driven tracks. In one design, the robot has rearward motor driven sprockets for the main tracks and rear driven tracks and rearward motors for pivoting the rear driven tracks. The obstacle may be a positive obstacle or a negative obstacle.

Preferably, the fixed angle of the pivoting rear driven tracked arms is selected based on the expected height of obstacles to be encountered by the robot. In one addition, the fixed angle of the pivoting rear driven tracked arms is further selected based on the length of the main driven tracks. In one embodiment, the fixed angle of the pivoting rear driven tracked arms is selected as a function of the arcsin of the ratio of the height of an obstacle and the length of the main driven tracks.

Also featured is a method of remotely controlling a ground robot including main right and left driven tracks and rear right and left pivotable arms each including a driven track via an operator control unit configured to operate the right and left driven tracks, the pivotable arms, and the pivotable arm driven tracks. The operator control unit is used to pivot the rear right and left pivotable arms to trail the main right and left driven tracks at a fixed angle relative to and above the ground. The operator control unit is used to operate the main right and left driven tracks to traverse the ground and to operate the driven tracks of the rear right and left pivotable arms. An obstacle is traversed by using the operator control unit to traverse an obstacle and, as the forward end of the robot pitches upward, the rear driven tracks engage the obstacle to advance the robot forward over the obstacle and preventing the robot from tipping over backwards.

In one embodiment, upon a mode command from the operator control unit, the rear right and left pivotable arms are automatically pivoted to trail the main right and left driven tracks at a fixed angle relative to and above the ground. The main right and left driven tracks are operated to traverse the ground and the driven tracks of the rear right and left pivotable arms are operated at the same speed as the main tracks.

Also featured is a method of operating a mobile remotely controlled ground robot in difficult terrain. The rear driven tracked arms of the robot are pivoted rearward and upward at a fixed angle θ to tail main driven tracks having a length L. The main tracks of the robot are driven forward to traverse the ground. The main tracks are driven to traverse an obstacle having a height h pivoting the forward end of the robot upwards. At least one of the rear driven tracks are driven and engage the ground and/or obstacle to advance the robot forward over the obstacle and to prevent the robot from tipping over backwards. Angle θ is approximately equal to arcsin(h/L).

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is schematic view of an example of a remotely controlled packable ground robot in accordance with an example of the invention;

FIGS. 2-6 are schematic views showing various configuration options for a robot in accordance with examples of the invention;

FIG. 7 is a schematic top view showing an example of the chassis component layout;

FIGS. 8-9 are schematic views showing an example of robot main track side pods;

FIG. 10 is a schematic cross sectional view showing and example of a compact rearward motor assembly in accordance with aspects of the invention;

FIG. 11 is an exploded view of the drive motor;

FIG. 12 is another view of the motor;

FIG. 13 is a schematic view showing an example of an operator control unit for the robot;

FIGS. 14-21 show an example of a remotely controlled ground robot traversing a positive obstacle;

FIG. 22 shows an example of a remotely controlled ground robot traversing a negative obstacle;

FIG. 23 shows an example of a mobile remotely controlled ground robot and its rearward center of gravity;

FIG. 24 is a view of a robot traversing a fallen tree; and

FIG. 25 is a view showing how the angle of the pivoting rear driven track arms is optimized based on the length of the robot's main wheelbase and the height of an obstacle.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

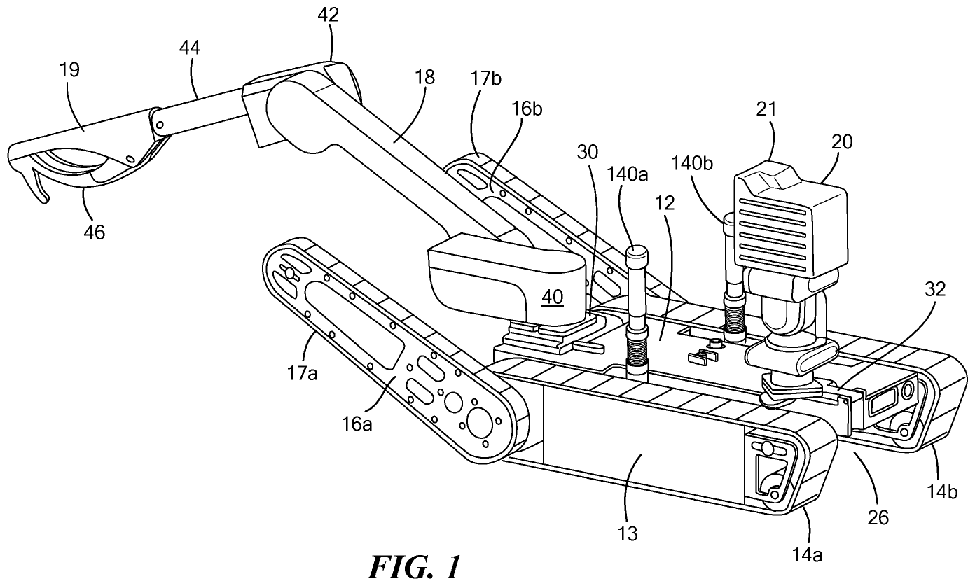

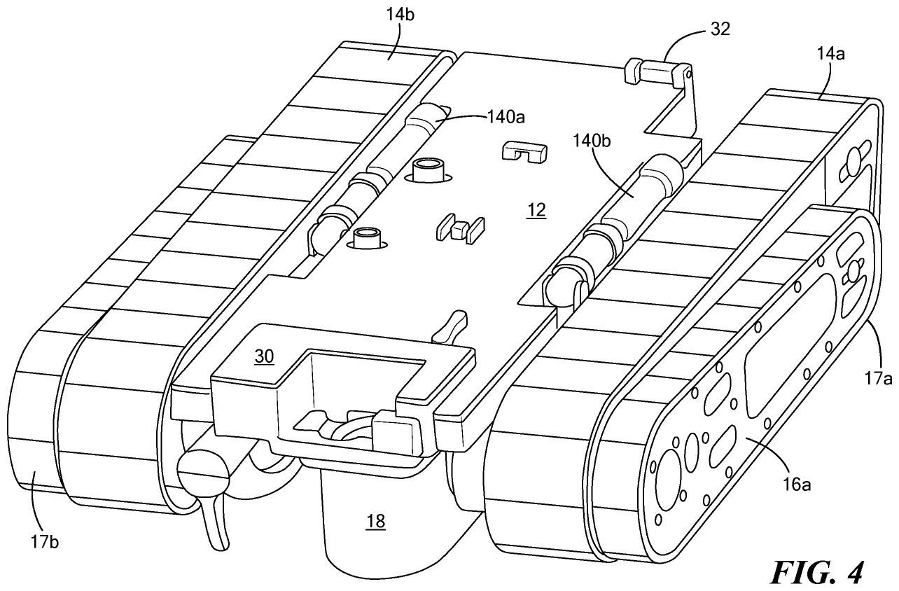

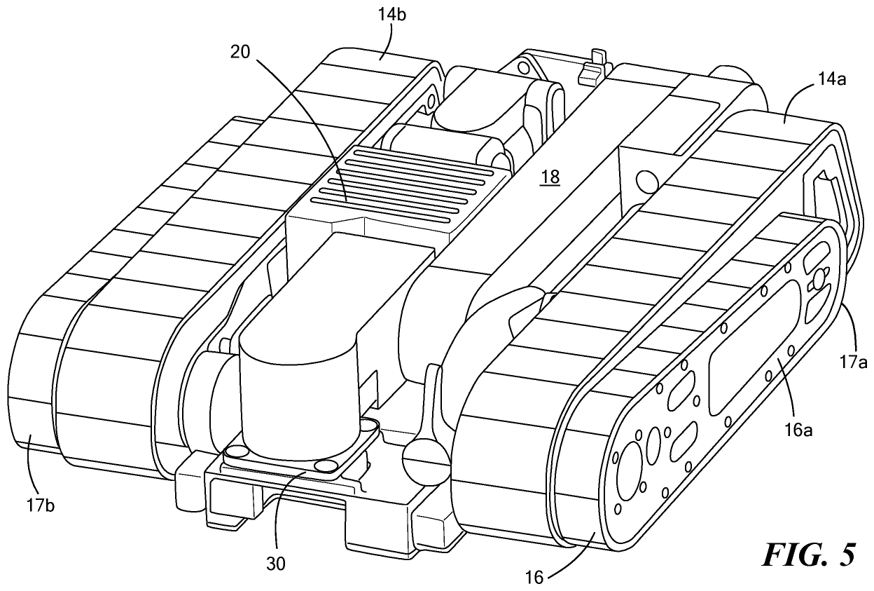

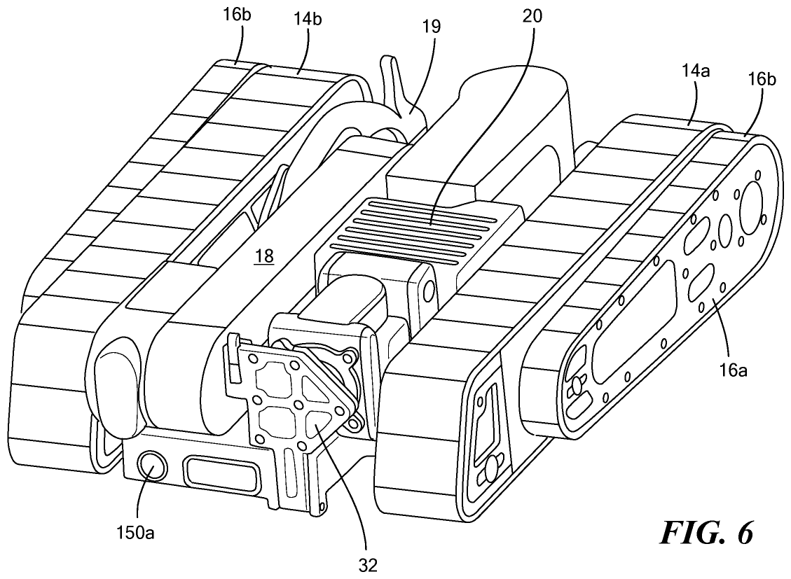

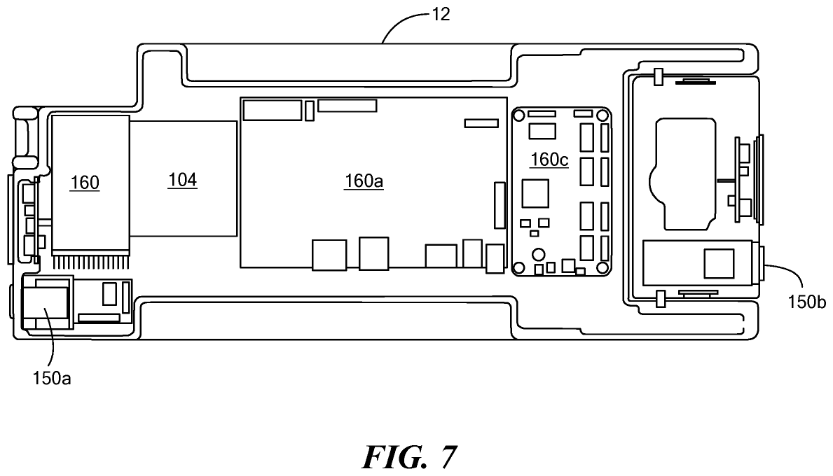

FIGS. 1-6 show an example of a remotely controlled packable robot 10 including a chassis 12. Right 14a and left 14b main tracks maneuver the chassis as do right 16a and left 16b rearward rotatable flipper arms with corresponding tracks 17a, 17b. Robot arm 18 with end effector 19 and/or camera assembly 20 may also be included.

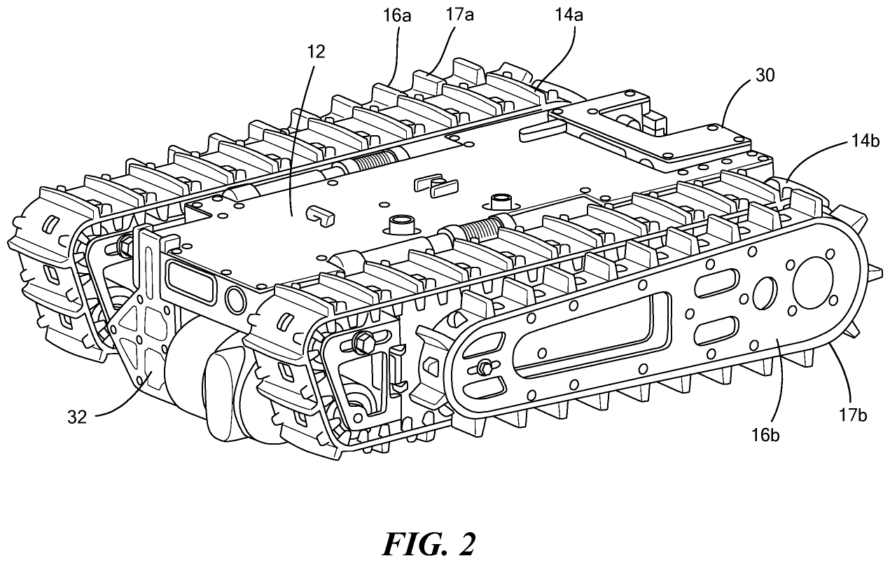

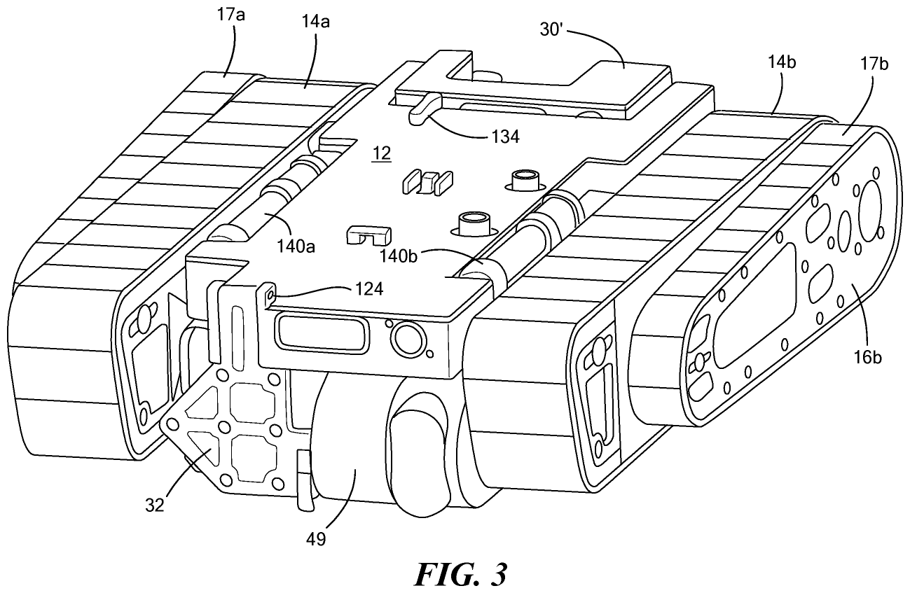

Chassis 12 is preferably thin and plate-like in construction and includes a top surface and a bottom surface disposed high (e.g., three inches) above the ground for clearance over obstacles. In this way, an open channel 26 under the robot is defined by the bottom surface of the chassis 12 and between the main tracks 14a and 14b. For transport in a backpack by a dismounted soldier or user, both the robot arm 18 and the camera assembly 20 may be folded underneath the robot chassis and reside almost completely in channel 26 as shown in FIGS. 2-3.

In one preferred design, robot arm 18 is mounted onto the top of foldable (e.g., pivotable) base plate member 30 rotatably coupled to the rear end of the chassis. The bottom of base plate member 30 is on the top of the chassis and the base plate member can be releasably secured to the top of the chassis 12 using, for example, a latch on chassis 12. Arm 18 in the deployed position extends upwards from the top surface of the chassis. In FIGS. 2-6, the arm base member 30 is folded relative to the chassis to a position depending downward from the chassis and the arm is stowed in the open channel under the robot next to the camera assembly.

Foldable (e.g., pivotable) base member plate 32f or the camera assembly 20 is rotatably coupled to the forward end of the chassis. The camera assembly 20 is coupled onto the top of this base member 32 and thus can be stowed in the open channel underneath the robot adjacent the robot arm and then deployed so camera assembly 20 extends upward from the top surface of the chassis. A latch can be used to releasably lock the bottom of camera assembly base member 32 into engagement with the top of the chassis. The robot arm and camera assembly can be manually stowed, deployed, and latched. Preferably, the base member plates 30, 32 rotate from a position where they lie on the top surface of the chassis to a position where they depend downward from an edge of the chassis (e.g., at a right angle to the plane of the chassis).

In one version, the robot is approximately 4 inches tall and 13 inches wide and 16 long with the arm and camera assembly in the stowed position and with the flipper arms also stowed. In the deployed position, the arm extends approximately 30 inches and the flipper arms when extended, make the robot approximately 25 inches long enabling maneuverability over obstacles and, for example, up and down stairs.

Motors in the robot arm 18 rotate shoulder 40 and elbow 42, rotate wrist 44, and open and close end effector 19 jaw 46. See also U.S. Pat. No. 8,176,808 incorporated herein by this reference. Camera assembly 21 may include motors to rotate and tilt the camera head 21 relative to base member 32. Camera head 21 may include a zoomable color camera as well as other imaging technology (e.g., infrared cameras, and the like).

FIG. 2 shows an example of a chassis component layout including a radio 104 for remotely communicating with the robot and for transmitting video signals back to an operator control unit from the camera assembly. Various other cameras 150, printed circuit boards, and processor and controller boards 160a-160c are also shown. Pixhawk (real-time controller with integrated inertial measurement unit), Ethernet switch, and Nitrogen (embedded Linux board) boards may be used. In other embodiments, only one controller board is used.

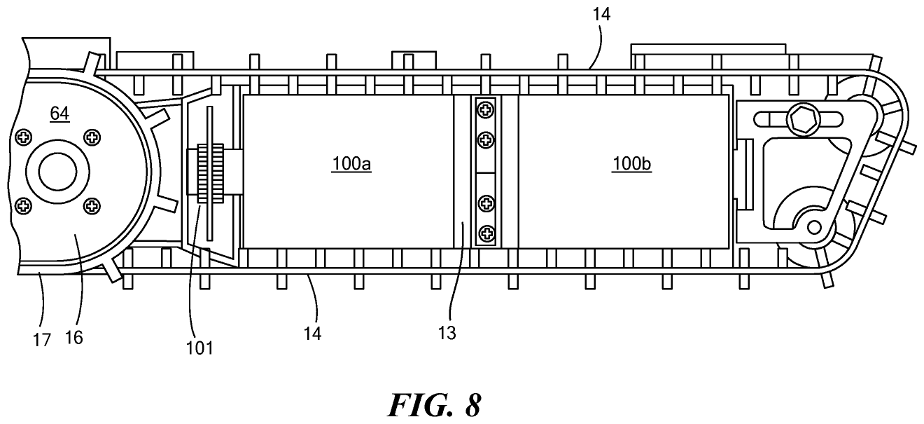

FIG. 8 shows two batteries 100a and 100b in a side pod 13 of a main track 14. Electronic speed controllers 101 can also be located in the side pod. This battery location provides a lower center of gravity for the robot and the batteries are hot swappable through a hinged door. Alternatively, a battery cage assembly slides into the sidepod.

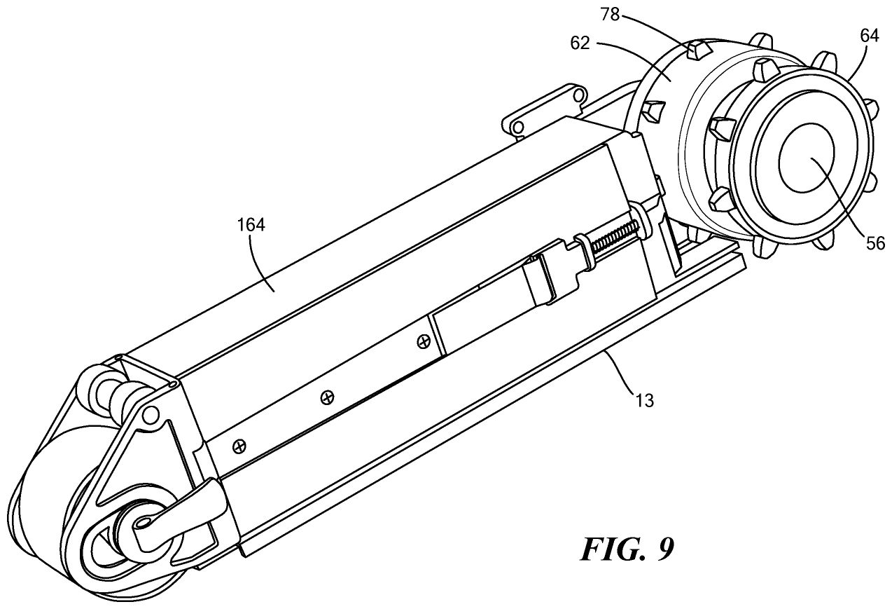

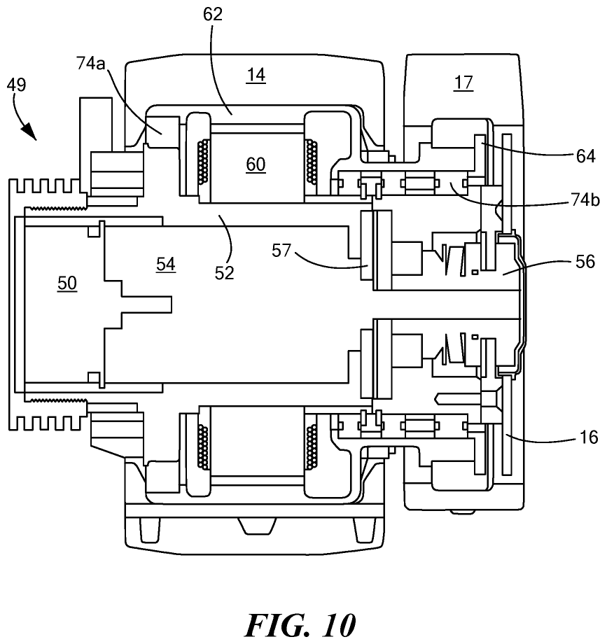

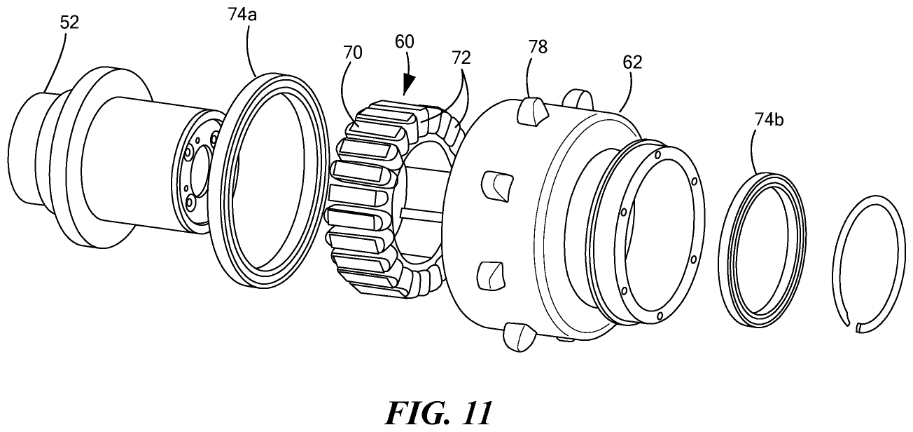

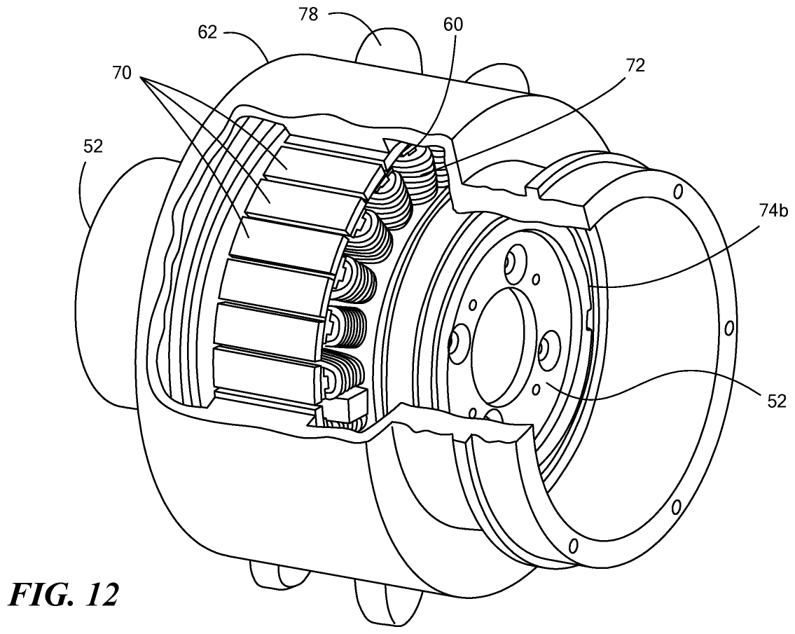

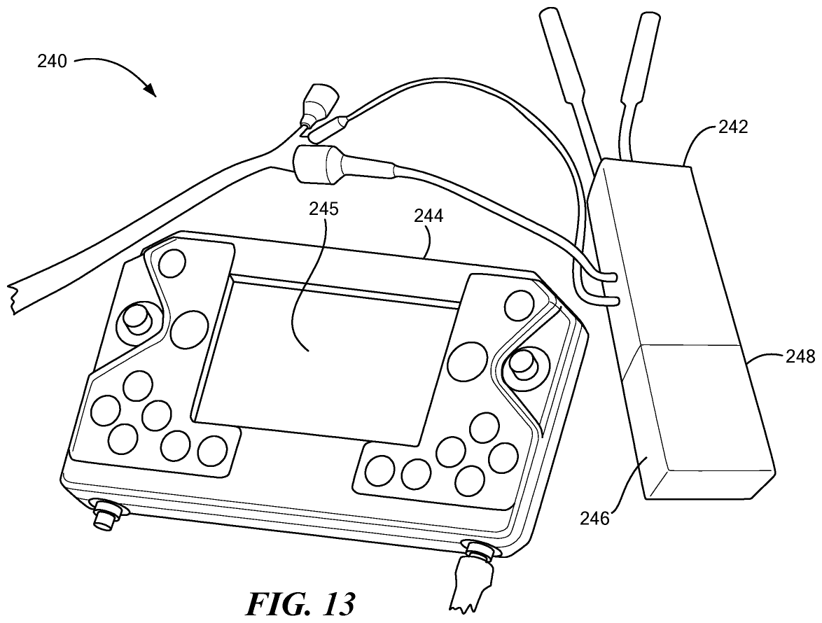

A preferred rearward integrated concentric drive assembly for each main track and flipper pair is shown in FIGS. 9-12. One such assembly, for example, would be rearwardly mounted to the chassis to drive right track 14a, rotate right rear flipper arm 16a, and drive its track 17a. Another such assembly would be mounted to the chassis and used to drive left track 14b, rotate left rear flipper arm 16b and drive its track 17b.

Preferably electric motor 50 is disposed inside motor housing 52 (coupled to the chassis) and rotates a flipper arm 16 via planetary gear box 54 and slip clutch 56 which is fixed to flipper arm 16. Slip clutch 56 prevents damage to the flipper arm if the robot is dropped. Encoder 57 enables the absolute location of the flipper arm to be known. Stator 60 and rotor 62 are disposed about motor housing 52 for driving a main track 14 and the flipper track 17 via sprocket 64. Stator 60 and rotor 62 are concentric with motor 50 housing 52.

In one design, stator ring 60 is a fixed about the housing 52 and includes teeth 70 each with a winding 72 thereabout. Rotor ring 62 can rotate about motor housing 52 via bearings 74a and 74b. Rotor 62 includes therein, inside the ring can, permanent magnets 80. Battery power is used to energize motor 50 and windings 72.

A main track 14 is disposed about rotor 62. Sprocket 64 has a flipper track 17 disposed about it. Sprocket 64 is coupled to rotor 62. In this way, rotation of the rotor rotates both a flipper track and a main track at the same speed. Rotor 62 may include exterior teeth 78 for driving a main track. In one example, motor 50 is an EC 32 Flat (339268) motor and 531:1 and gear box 54 is a 531:1 32C Planetary Gear Head available from Maxon Precision Motors, Inc.

The operator control unit 240, FIG. 34 is preferably configured to fit in an outside pocket of a pack. The operator control unit 240 may include radio 242 and hand controller 244. The hand controller may connect to a Persistent systems radio via an RJ45 connector so that the hand controller easily swaps between different radios, for example a radio in RF communication with an unmanned aerial vehicle. The hand controller features a tablet and also its own radio powered from a single BT-70716BG battery. The DC to DC converter shown supplies 16 volts to the hand controller 244. The battery is hot swappable and the tablet's battery then powers the tablet during the swap.

An example of an operator control unit is shown in U.S. Pat. No. 9,014,874 incorporated herein by this reference. In some embodiments, an operator control unit may include a hardened military style tablet device. The operator control unit allows the operator to wirelessly and remotely drive the robot, to vary the speed and direction of the main tracks, to vary the speed and direction of the rear tracks, and to rotate the rear arms and their tracks. Commands from the OCU are wirelessly sent to the robot and processed to control the various motors of the robot.

In one embodiment, the operator selects, on the OCU a mode command selection (e.g., “obstacle mode”) and in response, the robot automatically assumes an obstacle mode of travel when the command selection is wirelessly sent from the OCU to the robot transceiver and processed by one or more controllers of the robot (see FIG. 2). Software instructions operating on the one or more controllers, in response to the command selection, automatically controls motor 50, FIGS. 9-12, to pivot the rear right and left pivotable arms to trail the main right and left driven tracks at a fixed angle relative to and above the ground. The operator then uses the OCU to drive the main and left driven tracks via which is effected via control of rotor 62. Since rotor 62 is coupled to sprocket 64, the arm/flipper tracks rotate at the same speed as the main tracks.

Preferably, the weight of the combined system is less than 32 pounds with the operator control unit weighting less than 5 pounds. In the folded configuration, the robot may fit in a tactical or assault backpack (MOLLE brand or others) which is approximately 16 inches high, 13 inches wide, and 4 inches thick. In one example, the MOLLE Assault Pack II NSN number is: 8465-01-580-0981. The robot can climb and descend 8.5 inch by 10 inch stairs, is self righting, and has a very low rearward center of gravity. At the same time, the robot has a fairly high ground clearance.

The chassis and side pods may be made of aluminum, the tracks can be made of polyurethane, and the flippers may be made of carbon fiber. The arm may be 4 pounds total weight, have a maximum reach of 26 inches and 5 pound lift capability at full extension. Preferably, non-back drivable gear boxes with slip clutches are used in the arm. The chassis may include cameras on the front, rear, and/or sides, for example, video and/or thermal cameras. The camera assembly may be equipped with a video camera, have a 360° continuous pan range, clockwise and counter clockwise rotation and a tilt range of −45° to +90°. Illumination sources, thermal cameras, and the like can also be equipped with the camera assembly.

In some embodiments, the base member 32 for the camera assembly includes a rotatable arm to which the camera assembly is attached. In this embodiment, the chassis also includes a U-shaped cut-out at the rear end thereof defining two spaced arms. The base member plate for the robot arm is located in the cut-out and is hinged between the two chassis arms and flips upside down relative to the chassis to store the arm underneath the robot. Various latch mechanisms retain the robot arm and the camera assembly in their deployed positions on the top of the chassis.

A spring loader slider on member 32 can be used in connection with a latch on chassis 12 to releasably lock member 32 on top of chassis 12. Member 32 pivots about hinge 124 when released. Member 30 may reside in a U-shape cut-out in the end of chassis 12 and pivots about hinges.

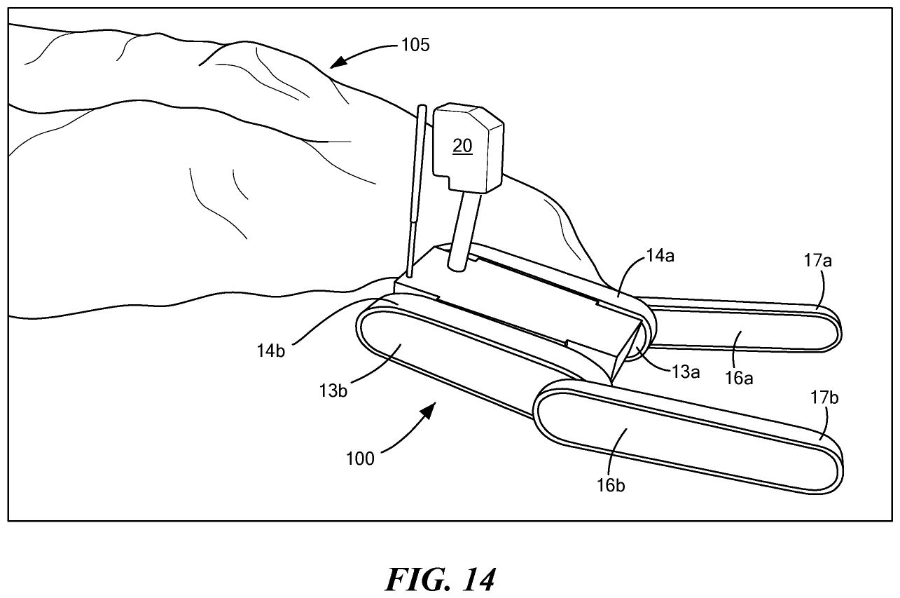

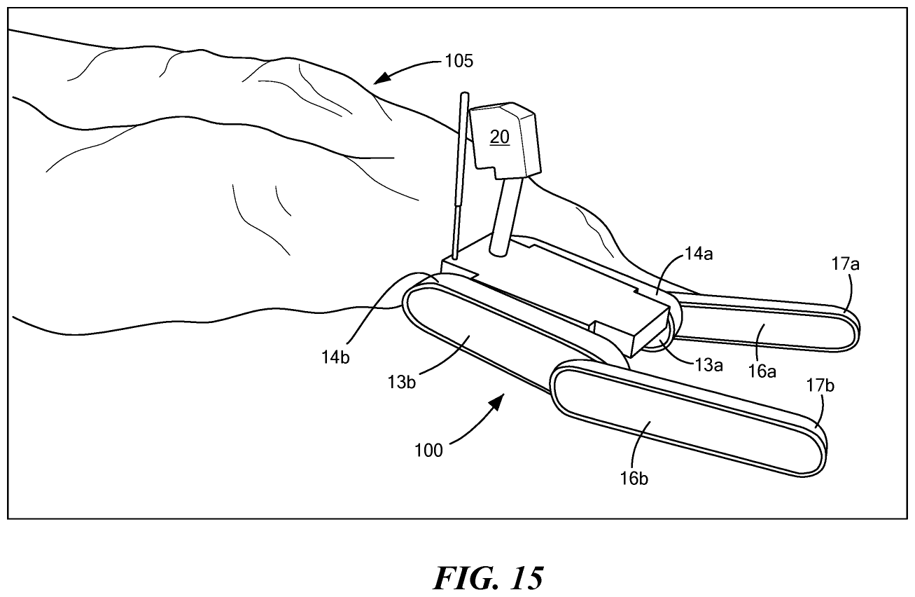

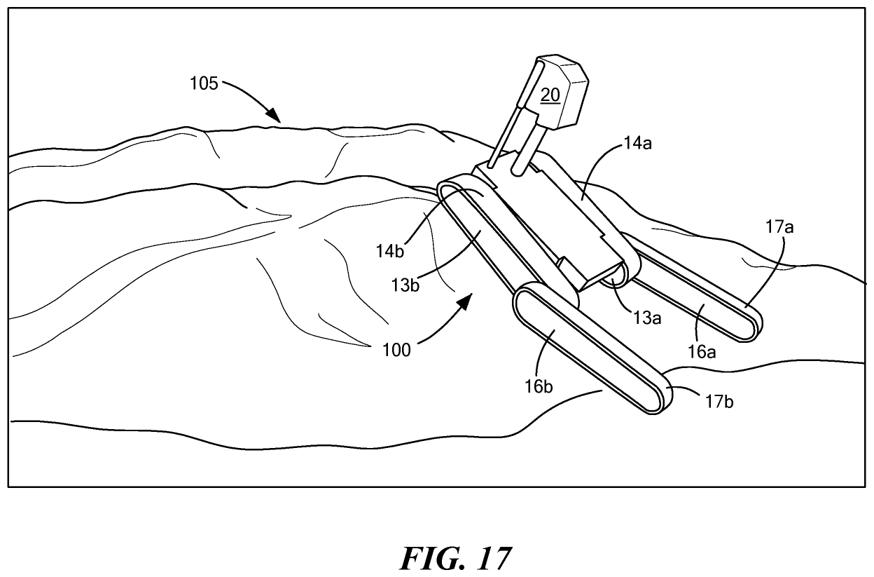

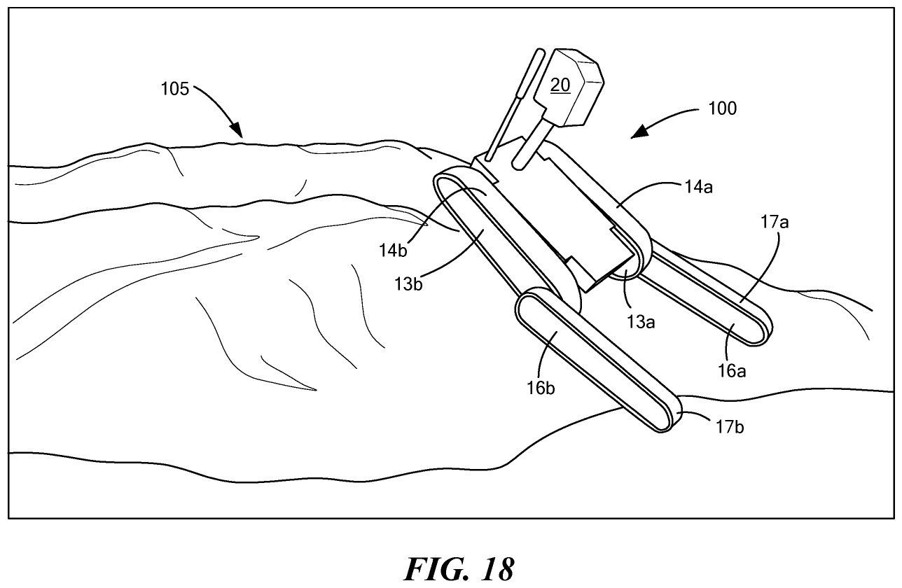

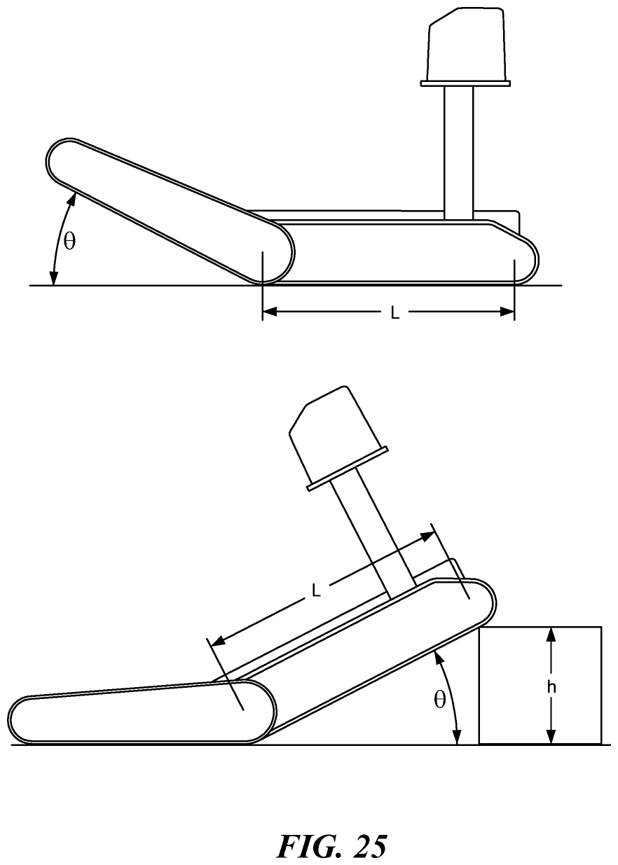

As shown in FIGS. 14-21, robot 100 includes driven main tracks 14a and 14b and pivoting rear driven tracks 17a and 17b on arms 16a, 16b. During maneuvering over difficult terrain, arm tracks 17a and 17b are preferably driven at the same speed as main tracks 14a and 14b and fixed at an angle θ relative to and above the extent of the main tracks and the ground (e.g., 10-60°). In other words, the rear arm tracks are pivoted rearward of the main tracks and pivoted upward with respect to the extent of the main tracks at angle θ. In some embodiments, angle θ may be specifically selected based on the size of obstacle that is expected. For example, if L is the length of the robot's main wheelbase as shown in FIG. 25, the highest obstacle that can be traversed, h, by tipping the chassis back onto the back flippers is approximately h=L*sin θ, implying a good choice of angle of approximately θ=arcsin(h/L). The rear tracks may be driven forward even during times they are not engaging the ground or an obstacle.

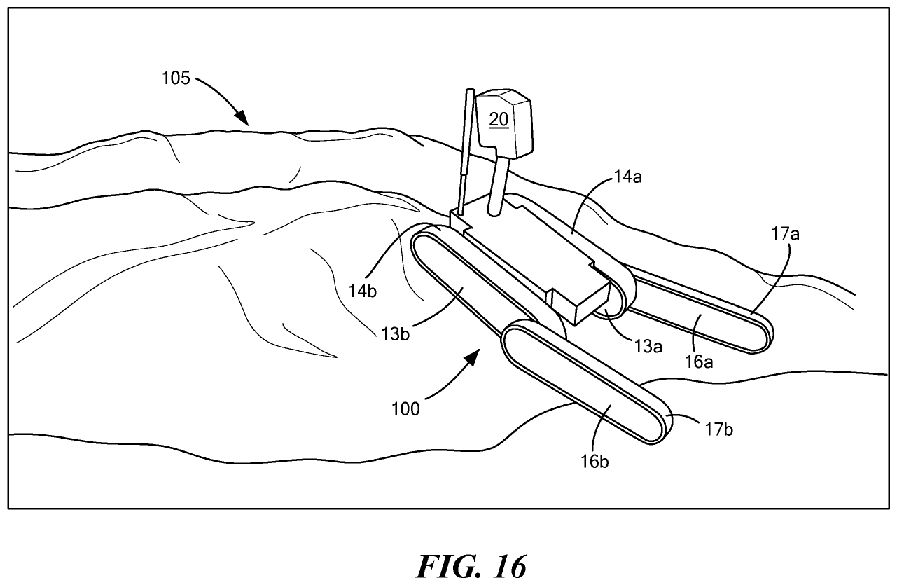

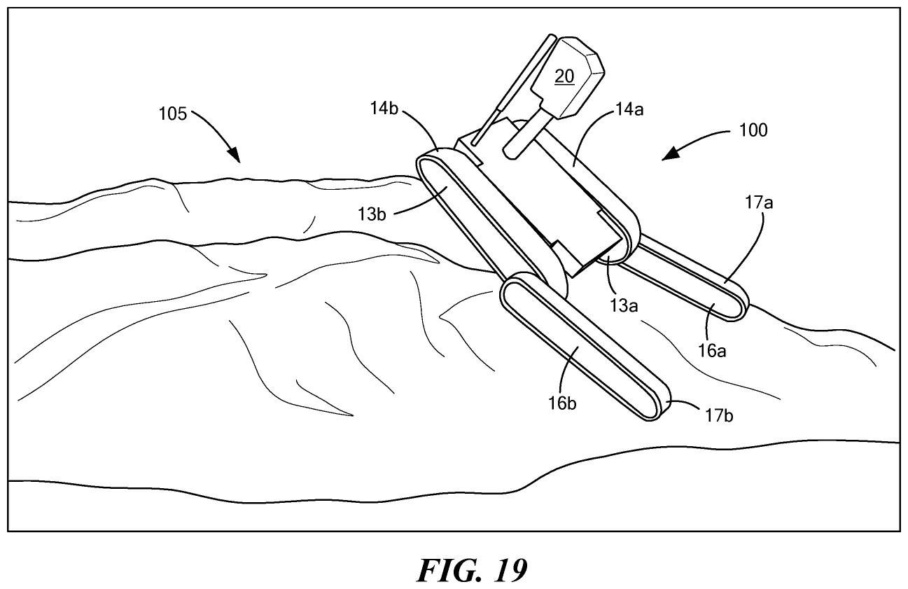

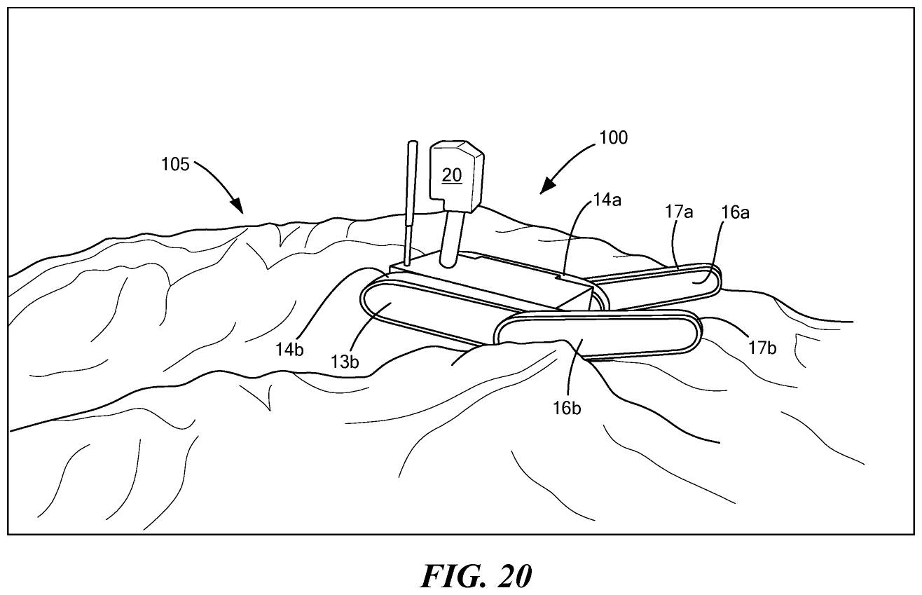

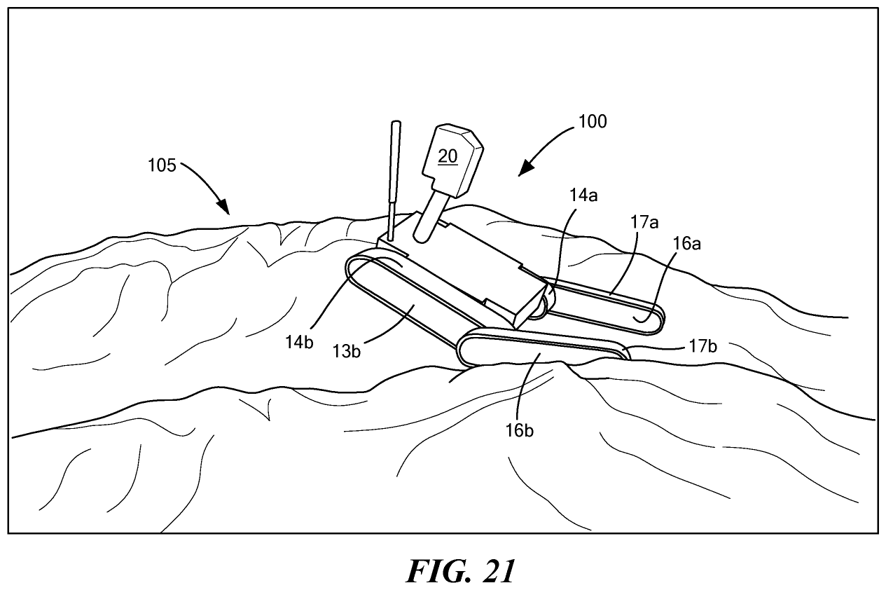

In this way, when a positive obstacle 105 is encountered, the main tracks 14a and 14b engage the obstacle in a manner which pivots the forward end of the robot upward as shown in FIG. 16. But, at least one of the rear driven tracks then engages the ground or other surface as shown in FIGS. 16-19 and, since the rear driven tracks are driven forward, the robot is advanced forward up and over the obstacle and, at the same time, the rear driven tracks prevent the robot from tipping over backwards. FIG. 19 shows how both rear driven tracks 17a and 17b are engaging the obstacle and prevent the robot from tipping over backwards. FIGS. 20-21 further show the robot advancing over the obstacle.

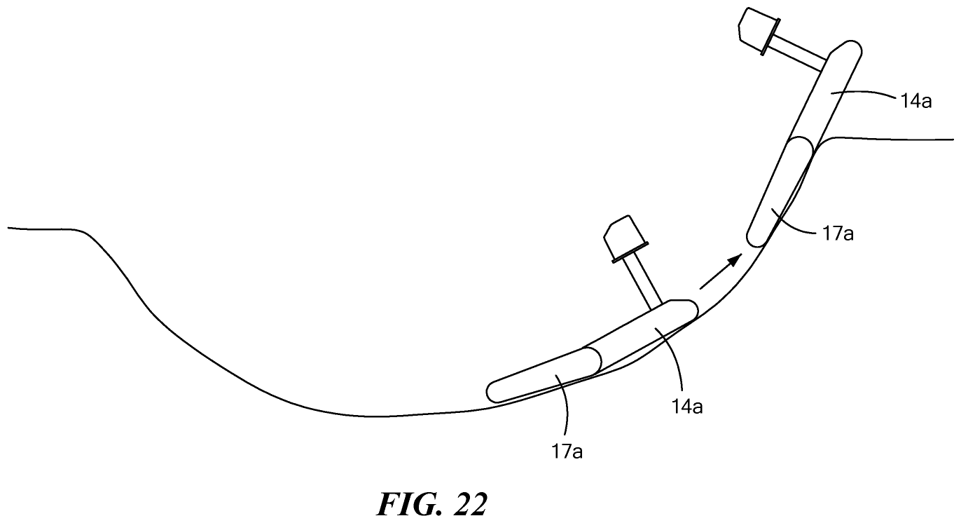

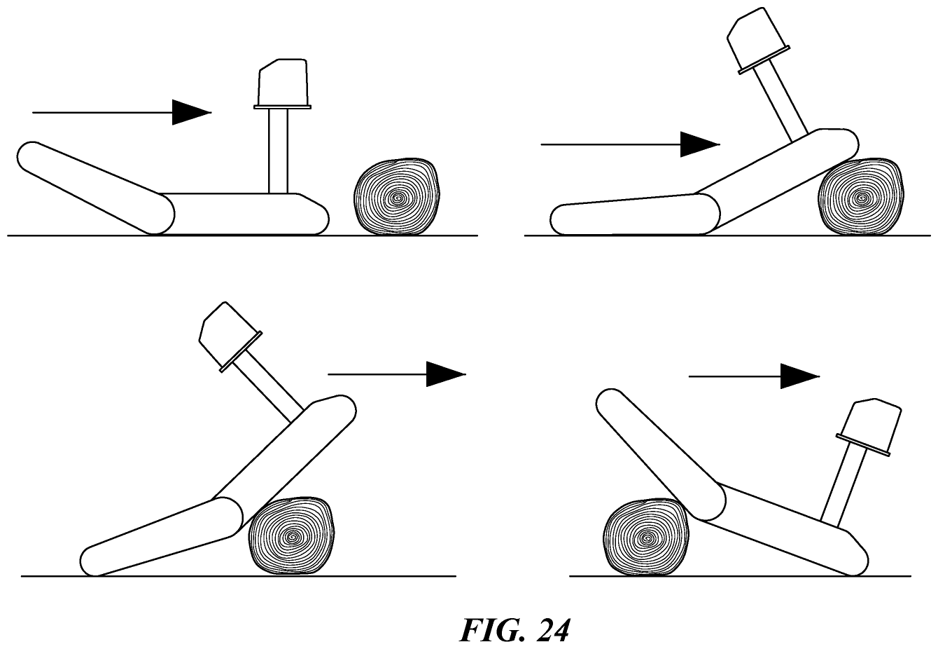

The obstacle can be a pile of sand or rubble, a rock or rocks, a fallen tree (see FIG. 24), a pipe, or the like. For positive obstacles that rise above the general plane of the ground, the rear driven tracks advance the robot over the obstacle and prevent the robot from tipping over backwards. For negative obstacles as shown in FIG. 22, the rear driven tracks advance the robot with respect to the obstacle and prevent the robot from tipping over backwards.

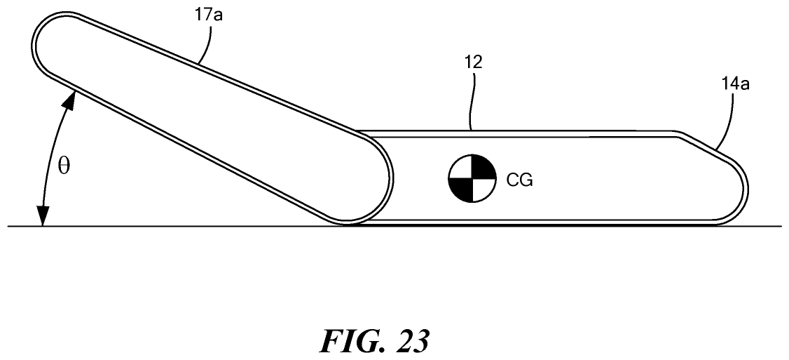

FIG. 23 shows how the center of gravity CG of the robot is located rearward of the front of the robot main driven tracks. The robot typically has rearward motor driven sprockets for the main tracks, the rear arm driven tracks, and motors for pivoting the rear arms as discussed above with reference to FIGS. 9-12. All these motors and sprockets and the associated gearing is located at the rearward end of the robot which moves the center of gravity of the robot rearward relative to the center of the robot main driven tracks. Many prior art robots tend to place the drive motors and the like far forward to move the center of gravity forward.

The main value of moving the CG rearward, in the context of moving over rough terrain, is that it lets the front of the main section rise upward more easily which is the same motion as the robot pivoting rearward on the fulcrum created at the rear of the main section when the rear arms are at an angle theta greater than zero. That is, the CG getting closer to the rear of the main section and the fulcrum that is created by the raised rear arms allows the pivoting action to more easily occur and this action contributes to the robot more easily traversing rough terrain, even at fast speeds in the manner described.

Keeping the rear tracks up off the ground for general and most maneuvering also keeps the overall length of effective track contact with the ground only to the length of the main tracks contact as opposed to if the angle θ is 0 and the rear tracks and the main tracks are effectively aligned and in contact together with a flat surface, this effective length being the length of the main tracks plus the length of the rear pivoting tracks. In this latter condition, the side forces on areas of the tracks are very high when the platform is pivoted to steer by driving the tracks at different speeds. The side forces and the side slipping of areas of the tracks during turning is inefficient, consumes more energy than simple straight motion, and places higher side loads on portions of the tracks and their respective supporting structures. By keeping the effective length of the track shorter during most maneuvering, the turning action produces less side force and less side slipping distances. Maneuvering is thus more efficient, less battery power is used, and steering is easier. Thus, it is beneficial to keep the rear tracks fixed at angle 9 greater than zero during many ground maneuvers.

In one design, the robot main track length is about 16½″ and the robot's width is about 11½″. This length to width aspect ratio ensures the robot can turn more easily and thus, during general maneuvering operations, it is beneficial for the rearward tracks to be raised an angle of θ greater than zero and not engage the ground. Of course, for other operations, it may be beneficial for the rear driven tracks to be at an angle θ of zero or even below zero (e.g., stair climbing operations and the like).

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

Other embodiments will occur to those skilled in the art and are within the following claims.

What is claimed is:

1. A method of operating a mobile remotely controlled ground robot in difficult terrain, the method comprising:
pivoting rear driven tracked arms of the robot to trail main driven tracks of the robot at a fixed angle relative to and above the ground;
driving the main tracks of the robot forward to traverse the ground;
traversing an obstacle by driving the main tracks to traverse an obstacle pivoting the forward end of the robot upwards; and
at least one of the rear driven tracks then driven and engaging the ground and/or obstacle to advance the robot forward over the obstacle and to prevent the robot from tipping over backwards.

2. The method of claim 1 in which both of the rear driven tracks are driven and engage the ground and/or obstacle.

3. The method of claim 1 in which the rear driven tracks are driven forward while the main tracks are driven forward to traverse the ground.

4. The method of claim 1 in which the rear driven tracks are driven at the same speed as the main driven tracks.

5. The method of claim 1 in which the center of gravity of the robot is rearward of the front of the robot main driven tracks.

6. The method of claim 5 in which the robot has rearward motor driven sprockets for the main tracks and rear driven tracks and rearward motors for pivoting the rear driven tracks.

7. The method of claim 1 in which the obstacle is a positive obstacle.

8. The method of claim 1 in which the obstacle is a negative obstacle.

9. The method claim 1 in which the fixed angle of the pivoting rear driven tracked arms is selected based on the expected height of obstacles to be encountered by the robot.

10. The method of claim 9 in which the fixed angle of the pivoting rear driven tracked arms is further selected based on the length of the main driven tracks.

11. The method of claim 10 in which the fixed angle of the pivoting rear driven tracked arms is selected as a function of the arcsin of the ratio of the height of an obstacle and the length of the main driven tracks.

12. A method of remotely controlling a ground robot including main right and left driven tracks and rear right and left pivotable arms each including a driven track via an operator control unit configured to operate the right and left driven tracks, the pivotable arms, and the pivotable arm driven tracks, the method comprising:
using the operator control unit to pivot the rear right and left pivotable arms to trail the main right and left driven tracks at a fixed angle relative to and above the ground;
using the operator control unit to operate the main right and left driven tracks to traverse the ground;
using the operator control unit to operate the driven tracks of the rear right and left pivotable arms; and
using the operator control unit to traverse an obstacle and, as the forward end of the robot pitches upward, the rear driven tracks engaging the obstacle to advance the robot forward over the obstacle and to prevent the robot from tipping over backwards.

13. The method of claim 12 including operating the main right and left driven tracks and rear driven tracks to rotate at the same speed.

14. The method of claim 12 which the robot has rearward motor driven sprockets for the main tracks and rear driven tracks and rearward motors for pivoting the rear right and left pivotable arms.

15. The method of claim 12 in which the obstacle is a positive obstacle.

16. The method of claim 12 in which the obstacle is a negative obstacle.

17. The method of claim 12 in which the fixed angle of the pivoting rear driven tracked arms is based on the height of the obstacle.

18. A method of remotely controlling a ground robot including main right and left driven tracks and rear right and left pivotable arms each including a driven track via an operator control unit configured to operate the right and left driven tracks, the pivotable arms, and the pivotable arm driven tracks, the method comprising:
upon a mode command from the operator control unit, automatically pivoting the rear right and left pivotable arms to trail the main right and left driven tracks at a fixed angle relative to and above the ground;
operating the main right and left driven tracks to traverse the ground; and
operating the driven tracks of the rear right and left pivotable arms at the same speed as the main tracks.

19. The method of claim 18 which the robot has rearward coupled motor driven sprockets for the main tracks and arm driven tracks and rearward motors for pivoting the rear right and left pivotable arms.

20. The method of claim 18 in which the fixed angle of the pivoting rear driven tracked arms is based on the expected height of obstacles to be encountered by the robot.

21. A method of operating a mobile remotely controlled ground robot in difficult terrain, the method comprising:
pivoting rear driven tracked arms of the robot rearward and upward at a fixed angle θ relative to main driven robot tracks having a length L;
driving the main tracks of the robot forward to traverse the ground;
traversing an obstacle having a height h by driving the main tracks to traverse an obstacle pivoting the forward end of the robot upwards; and
at least one of the rear driven tracks then driven and engaging the ground and/or obstacle to advance the robot forward over the obstacle and to prevent the robot from tipping over backwards, wherein angle θ is approximately equal to arcsin(h/L).
